(19) United States
(12) Patent Application Publication
(10) Pub. No.: US 2010/0146430 A1
(43) Pub. Date: Jun. 10, 2010

(54) METHOD AND APPARATUS FOR DISPLAYING A WINDOW OVER A SELECTABLE HOME SCREEN

(75) Inventor: Kimmo Juhani Karimaki, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/328,760

(22) Filed: Dec. 4, 2008

(51) Int. Cl. G06F 3/048

(52) U.S. Cl. 715/781

(57) ABSTRACT

In accordance with an example embodiment of the present invention, an apparatus comprising a user interface configured to display a selectable home screen, display a window over at least part of the selectable home screen, display a feature in the window, allow use of the feature in the window, select the selectable home screen, and close the window based at least in part on the selection of the selectable home screen.

### TECHNICAL FIELD

The present application relates generally to displaying a window over a selectable home screen.

### BACKGROUND

A user may use an electronic device to use applications. Further, the electronic device may provide different types of applications. As such, the electronic device facilitates use different types of applications.

### SUMMARY

Various aspects of examples of the invention are set out in the claims.

According to a first aspect of the present invention, an apparatus comprising a user interface configured to display a selectable home screen, display a window over at least part of the selectable home screen, display a feature in the window, allow use of the feature in the window, select the selectable home screen, and close the window based at least in part on the selection of the selectable home screen.

According to a second aspect of the present invention, a method comprising displaying a selectable home screen, displaying a window over at least part of the selectable home screen, displaying a feature in the window, allowing use of the feature in the window, selecting the selectable home screen, and closing the window based at least in part on the selection of the selectable home screen.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2A is a block diagram of an electronic device operating in accordance with an example embodiment of the invention;

FIG. 2B is a block diagram of the electronic device of FIG. 2A operating in accordance with an example embodiment of the invention;

FIG. 2C is a block diagram of the electronic device of FIG. 2A operating in accordance with an example embodiment of the invention;

FIG. 3 is a flow diagram depicting example method for updating a selectable home screen in accordance with an example embodiment of the invention; and

FIG. 4 is a block diagram of a media player operating on an electronic device in accordance with an example embodiment of the invention.

### DETAILED DESCRIPTION OF THE DRAWINGS

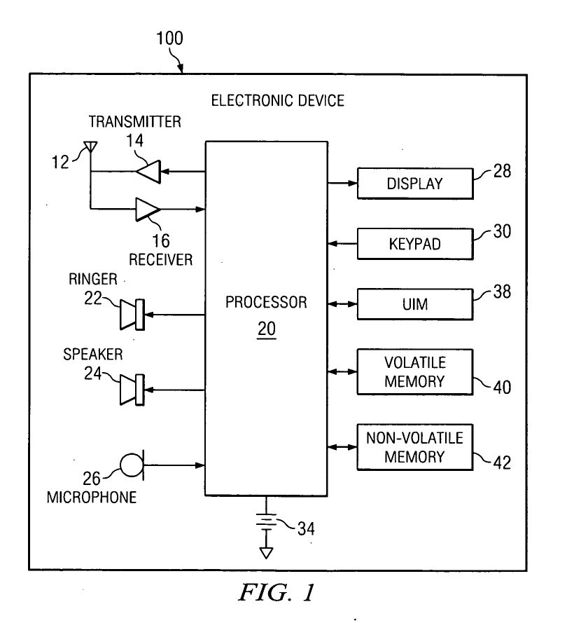

An example embodiment of the present invention and its potential advantages are best understood by referring to FIGS. 1 through 4 of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, the one or more output devices of the user interface may be coupled to the processor 20.

In an example embodiment, the user interface allows the electronic device 100 to receive or transmit data. For example, the user interface may comprise any of a number of devices configured to receive data, such as a keypad 30, a touch display, other input device, and/or the like. In an embodiment, the keypad 30 may comprise the conventional numeric, e.g., 0-9, and/or related keys, e.g., #, *, other hard and/or soft keys, and/or the like to operate the electronic device 100. In an alternative embodiment, the keypad 30 may comprise a conventional QWERTY keypad arrangement. Further, the keypad 30 may also comprise various soft keys with associated features. If desired, the electronic device 100 may comprise a user interface device, such as a joystick or the like.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 may comprise memory. For example, the processor 20 may comprise volatile memory 40, non-volatile memory 42, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprises signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

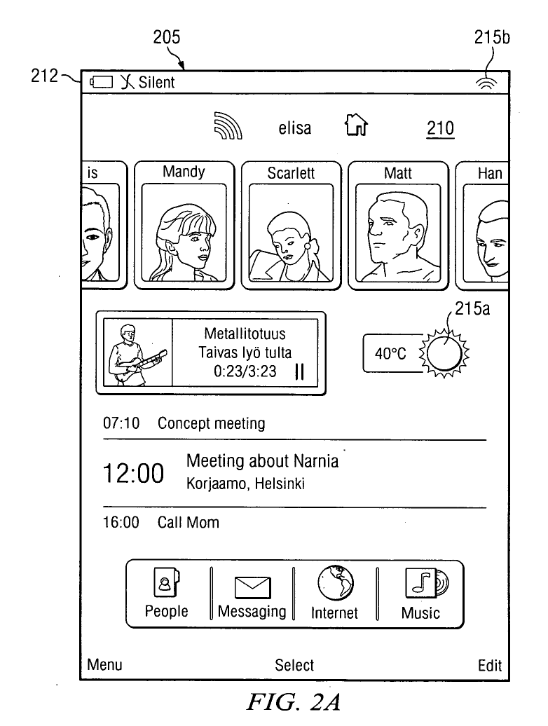

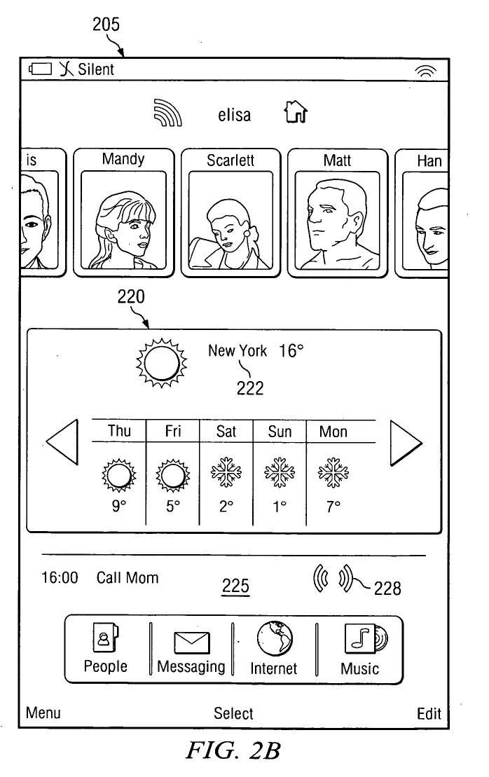

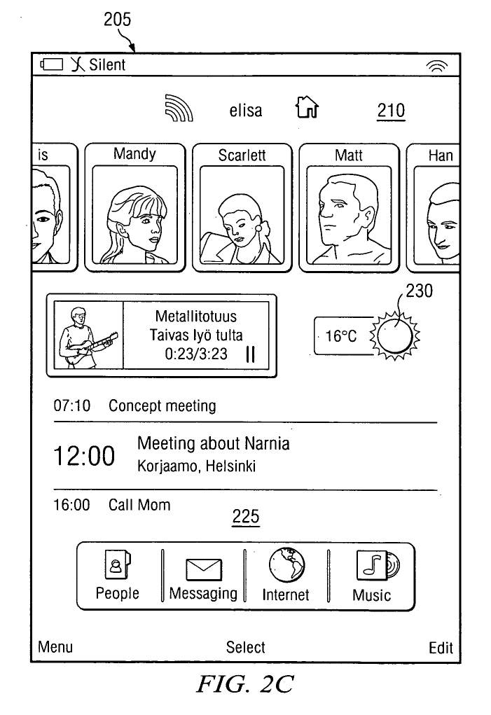

FIG. 2A is a block diagram of an electronic device 205 operating in accordance with an example embodiment of the invention. In an example embodiment, the electronic device 205 comprises a user interface 210.

In an embodiment, the user interface 210 may be configured to display an indicator 215a and an indicator pane 212 on a home screen 210. In an embodiment, the indicators 215a may be a link to a widget. In an embodiment, a widget may be an interactive element of a graphical user interface (GUI). It should be understood that the user interface 210 may be configured to display any number of indicators.

In an example embodiment, the indicator 215a on the home screen 210 is a selectable link to access a window, such a weather widget. For example, the user interface may display an indicator 215a related to weather for a city on the home screen 210. The indicator 215a may be clicked or otherwise activated to access a feature, such as selecting a city associated with the weather. In an example embodiment, the feature relates to at least one of the following: setup, configuration, battery, clock, widget, media, weather, media player, podcast application, image sharing application, email client, calendar client, really simple syndication (RSS) reader, and/or the like.

In an example embodiment, the indicator pane 212 may comprise one or more indicators, such as indicator 215b. In an example embodiment, the indicator 215b of the indicator pane 212 is a selectable link to access to a window. For example, the indicator 215b may be a link to a wireless configuration window for the electronic device 205. The window may display status information related to the indicator 215a. For example, the window may display wireless connection status for the electronic device 205.

In an alternative embodiment, the indicator pane 212 may be configured to be selectable. For example, the indicator pane 212 area may be clicked or otherwise selected. In such a case, the user interface 210 may be configured to display a window associated with the indicator pane 212. For example, the window may display status information related to the indicator pane 212. Further, the window may display wireless signal, clock, battery information, and/or the like associated with the electronic device 205.

FIG. 2B is a block diagram of the electronic device of FIG. 2A operating in accordance with an example embodiment of the invention. In an example embodiment, the user interface 210 is be configured to display a selectable home screen 225. Further, the user interface 210 is configured to display a window 220 over at least part of the selectable home screen 225.

In an embodiment, the window 220 may comprise a widget. For example, the window 220 comprises a weather widget. In an embodiment, the user interface 210 may be configured to display a feature in the window 220. For example, the user interface 210 may display a feature, such as a city 222 configuration, associated with the weather widget in the window 220. In an embodiment, the user interface 210 may be configured to allow use of the feature in the window 220. For example, the user interface 210 allows a user to change the city 222 from New York to Boston.

In an example embodiment, the user interface 210 is configured to allow selection of the selectable home screen 225. For example, the user interface 210 allows a user to select the selectable home screen 225 using a screen click on the selectable home screen 225. In an example embodiment, the user interface 210 may be configured to close the window 220 based at least in part on the selection, e.g., the screen click, of the selectable home screen 225. In an example embodiment, the selectable home screen 225 is a background for the window 220. In an alternative embodiment, the user interface 210 may be configured to close the window 220 based at least in part on a timeout. For example, a user may configure a timeout to be greater than 30 seconds. In such a case, the user interface 210 closes the window 220 after 30 seconds. A possible technical effect of one or more of the example embodiments disclosed herein is to close the window 220 by selecting the selectable home screen 225.

In an alternative embodiment, the user interface 210 may be configured to display an icon 228 in the window 220. The user interface 210 may allow selection of the icon 228 to access the selectable home screen 225. For example, the user interface 210 may allow a user to select the selectable home screen 225 by clicking on the icon 228. In such a case, the user interface 210 is configured to close the window 220 in accordance with example embodiments.

FIG. 2C is a block diagram of the electronic device of FIG. 2A operating in accordance with an example embodiment of the invention.

In an example embodiment, a user interface 210 is configured to update the selectable home screen 225 based at least in part on the use of a feature in a window, such as window 220 of FIG. 2B. For example, the user interface 210 allows a user to use a feature relating to a city change, such as changing city 222 of FIG. 2B from New York to Boston, in a window, such as window 220 of FIG. 2B. In such a case, a user closes the window by selecting the selectable home screen 225. The user interface updates the selectable home screen 225 based on the new city. For example, the user interface 210 displays weather 230 on the selectable home screen 225 for the Boston instead of New York. A possible technical effect of one or more of the example embodiments disclosed herein is to update the selectable home screen 225 based at least in part on the use of the feature in the window.

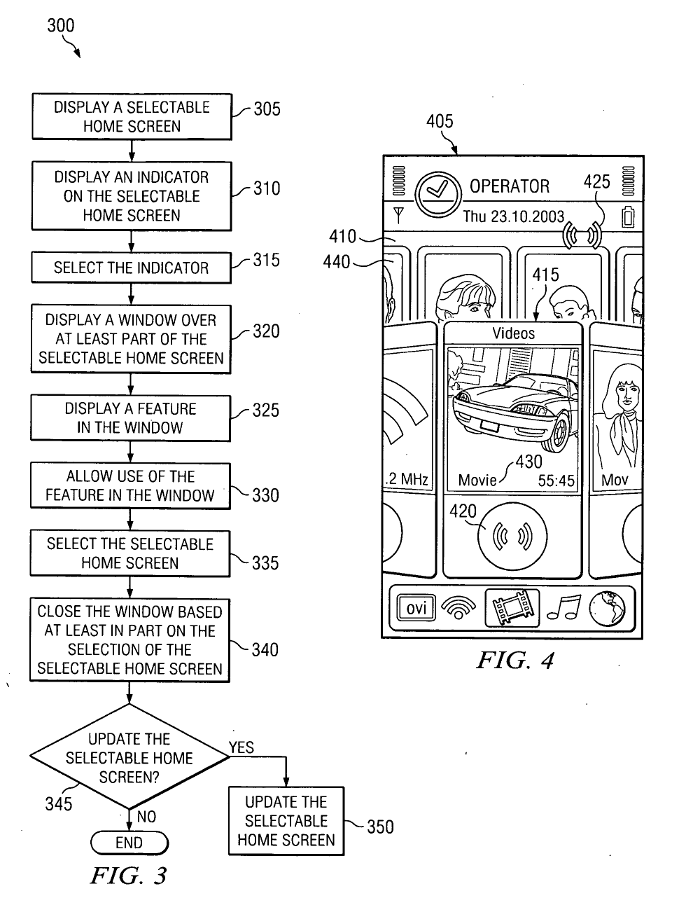

FIG. 3 is a flow diagram depicting example method 300 for updating a selectable home screen in accordance with an example embodiment of the invention. Example method 300 may be performed by an electronic device, such as electronic device 205 of FIG. 2A.

At 305, a selectable home screen is displayed. In an example embodiment, a user interface, such as user interface 210 of FIG. 2A, displays a selectable home screen, such as selectable home screen 225 of FIG. 2B, on the electronic device.

At 310, an indicator is displayed on the selectable home screen. In an example embodiment, the indicator is a link to a widget. In an embodiment, a widget may be an interactive element of a graphical user interface (GUI). In an example embodiment, the user interface displays an indicator, such as indicator 215a of FIG. 2A, on the selectable home screen. For example, the user interface displays an indicator to a weather widget.

At 315, the indicator is selected. In an example embodiment, a user of the user interface selects the indicator. For example, the user may click or otherwise select the indicator to open a window, such as window 220 of FIG. 2B, relating to a weather widget.

At 320, a window is displayed over at least part of the selectable home screen. In an example embodiment, the user interface displays a window over at least part of the selectable home screen. For example, the user interface displays a window with weather information for a city over the selectable home screen and part of the selectable home screen is visible.

At 325, a feature in the window is displayed. In an example embodiment, the user interface displays a feature in the window. For example, the user interface displays a configuration area to change the city in the weather widget window. In an example embodiment, the feature relates to at least one of the following: setup, configuration, battery, clock, widget, media, weather, media player, podcast application, image sharing application, email client, calendar client, really simple syndication (RSS) reader, and/or the like.

At 330, use of the feature in the window is allowed. In an example embodiment, the user interface is configured to allow use of the feature in the window. For example, the user interface allows a user to change the city in the weather widget window.

At 335, the selectable home screen is selected. In an example embodiment, the user clicks on the indicator displayed at 310 to select the selectable home screen. In an alternative embodiment, a user may perform a screen click on the selectable home screen.

At 340, the window is closed based at least in part on the selection of the selectable home screen. In an example embodiment, the user interface is configured to close the window when the selectable home screen is selected. For example, the user interface closes the selectable home screen when a user clicks on the indicator displayed at 310.

At 345, it is determined whether the selectable home screen is to be updated. In an example embodiment, the user interface is configured to determine if the feature in the window has been modified. If the feature has been modified, the selectable home screen is updated. For example, if a user changes the display city, e.g., the feature, in the weather widget window, then the selectable home screen is to be updated with a new city.

If at 345 it is determined that the selectable home screen is to be updated, then at 350 the selectable home screen is updated. For example, the user interface displays a new city on the selectable home screen based at least in part on the feature use at 330. The example method 300 ends.

If at 345 it is determined that the selectable home screen is not to be updated, the example method 300 ends.

FIG. 4 is a block diagram of a media player 415 operating on an electronic device 405 in accordance with an example embodiment of the invention. In an example embodiment, an electronic device 405 comprises a user interface 410. In an embodiment, the user interface 410 may be configured to display a media player 415, a media 430, a play button 420, an indicator 425, and at least a portion of a selectable home screen 440. In an example embodiment, the electronic device 405 is similar to electronic device 205 of FIG. 2A and the user interface 410 is similar to user interface 210 of FIG. 2A. In an alternative embodiment, the electronic device 405 may be different than the electronic device 205 of FIG. 2A and/or the user interface 410 may be different than the user interface 210 of FIG. 2A.

In an example embodiment, the user interface 410 displays the media player 415 over a portion of the selectable home screen 440 in accordance with example embodiments. The user interface 410 is configured to allow a user to use the media player 415 over the selectable home screen 440. For example, a user views a media 430, such as a movie by selecting the play button 420 while the selectable home screen 440 is partially visible. It should be understood that the media player 415 may operate in any number of ways as known in the art.

In an example embodiment, the user interface 410 displays the indicator 425. In an embodiment, the user interface 410 may allow selection of the indicator 425 to access the selectable home screen 440. For example, the user interface 410 may allow a user to select the selectable home screen 440 by clicking on the indicator 425. In such a case, the user interface 410 is configured to close the media player 415. The user interface 410 displays the selectable home screen 440. It should be understood that the media player 415 may be accessed by employing example embodiments.

Without in any way limiting the scope, interpretation, or application of the claims appearing below, it is possible that a technical effect of one or more of the example embodiments disclosed herein may be to close a window by selecting a selectable home screen. Another possible technical effect of one or more of the example embodiments disclosed herein is to update the selectable home screen based at least in part on the use of a feature in a window.

Embodiments of the present invention may be implemented in software, hardware, application logic or a combination of software, hardware and application logic. The software, application logic and/or hardware may reside on an electronic device or a server. If desired, part of the software, application logic and/or hardware may reside on an electronic device, and part of the software, application logic and/or hardware may reside on server. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a user interface configured to:
display a selectable home screen;
display a window over at least part of the selectable home screen;
display a feature in the window;
allow use of the feature in the window;
select the selectable home screen; and
close the window based at least in part on the selection of the selectable home screen.

2. The apparatus of claim 1 wherein the window comprises a widget.

3. The apparatus of claim 1 wherein the feature relates to at least one of the following: setup, configuration, battery, clock, widget, media, weather, media player, podcast application, image sharing application, email client, calendar client, really simple syndication (RSS) reader.

4. The apparatus of claim 1 wherein the selection of the selectable home screen is a screen click on the selectable home screen.

5. The apparatus of claim 1 wherein the user interface is further configured to display an icon on the selectable home screen for use in selection of the selectable home screen.

6. The apparatus of claim 1 wherein the user interface is further configured to update the selectable home screen.

7. The apparatus of claim 6 wherein the selectable home screen is updated based at least in part on the use of the feature in the window.

8. The apparatus of claim 1 wherein the user interface is further configured to display an indicator on the selectable home screen to access the feature.

9. The apparatus of claim 8 wherein the indicator is a link to a widget.

10. The apparatus of claim 1, wherein the processor comprises at least one memory that contains executable instructions that if executed by the processor cause the apparatus to display a selectable home screen; display a window over at least part of the selectable home screen; display a feature in the window; allow use of the feature in the window; select the selectable home screen; and close the window based at least in part on the selection of the selectable home screen.

11. A method, comprising:
displaying a selectable home screen;
displaying a window over at least part of the selectable home screen;
displaying a feature in the window;
allowing use of the feature in the window;
selecting the selectable home screen; and
closing the window based at least in part on the selection of the selectable home screen.

12. The method of claim 11 wherein the window comprises a widget.

13. The method of claim 11 wherein the feature relates to at least one of the following: setup, configuration, battery, clock, widget, media, weather, media player, podcast application, image sharing application, email client, calendar client, really simple syndication (RSS) reader.

14. The method of claim 11 wherein selecting the selectable home screen is a screen click on the selectable home screen.

15. The method of claim 11 further comprising displaying an icon on the selectable home screen for use in selecting of the selectable home screen.

16. The method of claim 11 further comprising updating the selectable home screen.

17. The method of claim 16 wherein the selectable home screen is updated based at least in part on the use of the feature in the window.

18. The method of claim 11 further comprising displaying an indicator on the selectable home screen to access the feature.

19. The method of claim 18 wherein the indicator is a link to a widget.

20. A computer program product comprising a computer-readable medium bearing computer program code embodied therein for use with a computer, the computer program code comprising:
code for displaying a selectable home screen;
code for displaying a window over at least part of the selectable home screen;
code for displaying a feature in the window;
code for allowing use of the feature in the window;
code for selecting of the selectable home screen; and
code for closing the window based at least in part on the selection of the selectable home screen.

21-35. (canceled)
